(19) United States
(12) Patent Application Publication
(10) Pub. No.: US 2021/0304237 A1
(43) Pub. Date: Sep. 30, 2021

(54) METHOD OF SHARING REVENUE FROM CONTENT GENERATED BY USER AND DEVICE FOR PROVIDING GAME

(71) Applicant: NEXON KOREA CORPORATION, Seongnam-si (KR)

(72) Inventor: Sae Byuk Moon, Seongnam-si (KR)

(21) Appl. No.: 17/213,643

(22) Filed: Mar. 26, 2021

(30) Foreign Application Priority Data
Mar. 30, 2020 (KR) 10-2020-0038555

(51) Int. Cl. G06Q 30/02; A63F 13/30; A63F 13/61

(52) U.S. Cl. CPC G06Q 30/0206; A63F 13/61; A63F 13/30

(57) ABSTRACT

Provided is a method of operating a game providing device, the method including: registering first content which is created by a first user in a first game; receiving a request for use of the first content from at least one user; and when the at least one user is permitted to use the first content, distributing revenue obtained from the first content or at least one piece of content which is based on the first content to the first user according to at least one revenue sharing criterion.

### CROSS-REFERENCE TO RELATED APPLICATION

This application is based on and claims priority under 35 U.S.C. § 119 to Korean Patent Application No. 10-2020-0038555, filed on Mar. 30, 2020, in the Korean Intellectual Property Office, the disclosure of which is incorporated by reference herein in its entirety.

### BACKGROUND

### 1. Field

One or more embodiments relate to a method of sharing revenue from content generated by a user and a device for providing a game.

### 2. Description of the Related Art

Recently, as the number of people who play games has increased, various types of games, such as video games, casual games including Tetris, strategy simulation games including Starcraft, and role-playing games, have been developed. Such games may be played offline or online.

Furthermore, in such a game, only content produced at the time of designing the game is provided to users. Therefore, there is a need to provide content reflecting users' tastes to increase the interest of users in games, and also, it is required to encourage users to share more content generates by themselves with other users.

### SUMMARY

When a plurality of users have contributed to the creation of content in a game, revenue obtained from the content may be distributed to the plurality of users according to a predetermined criterion.

Revenue obtained from content of a game may be distributed to users to make the game more popular and users more interested in the game.

In addition, a user who has created content based on which another content is created may be rewarded.

Additional aspects will be set forth in part in the description which follows and, in part, will be apparent from the description, or may be learned by practice of the presented embodiments of the disclosure.

According to one or more embodiments, there is provided a method of operating a game providing device, the method including: registering first content which is created by a first user in a first game; receiving a request for use of the first content from at least one user; and when the at least one user is permitted to use the first content, distributing revenue, obtained from the first content or at least one piece of content which is based on the first content, to the first user according to at least one revenue sharing criterion.

According to one or more embodiments, there is provided a computer program stored in a non-transitory medium for executing the method of operating a game providing device in combination with the game providing device.

According to one or more embodiments, a non-transitory computer-readable recording medium has recorded thereon a program for executing the method of operating a game providing device.

According to one or more embodiments, a game providing device includes: a communication device; a storage; a processor; and a memory storing instructions executable by the processor, wherein the processor executes the instructions to: register first content which is created by a first user in a first game; receive a request for use of the first content from at least one user; and when the at least one user is permitted to use the first content, distribute revenue, obtained from the first content or at least one piece of content which is based on the first content, to the first user according to at least one revenue sharing criterion.

### BRIEF DESCRIPTION OF THE DRAWINGS

The above and other aspects, features, and advantages of certain embodiments of the disclosure will be more apparent from the following description taken in conjunction with the accompanying drawings.

The present disclosure may be easily understood by the following description in conjunction with the accompanying drawings, and reference numerals refer to structural elements.

FIG. 1 is a view illustrating an online game providing system including a server and clients according to an embodiment;

FIG. 2A is a view illustrating a method of operating an electronic device of a user according to an embodiment;

FIG. 2B is a flowchart illustrating a method of operating a game providing device according to an embodiment;

FIG. 3 is a view illustrating a method of distributing revenue obtained from content generated based on first content according to an embodiment;

FIG. 4 is a view illustrating a process in which a user generates content in a game according to an embodiment;

FIG. 5 is a view illustrating a process in which a user registers content in a game according to an embodiment;

FIG. 6 is a view illustrating a screen displaying content registered in a game according to an embodiment;

FIG. 7A is a view illustrating a process of setting a revenue sharing criterion according to an embodiment;

FIG. 7B is a view illustrating a process of setting a revenue sharing criterion according to another embodiment;

FIG. 8 is a view illustrating a process of recommending a revenue sharing criterion when content similar to registered content is detected, according to an embodiment;

FIG. 9 is a view illustrating a screen which displays a warning message when content generated by a user violates a predetermined criterion, according to an embodiment;

FIG. 10 is a view illustrating a process of adjusting a revenue sharing criterion based on information about the trend of revenue obtained from second content, which is generated based on first content, and the similarity between the first content and the second content, according to an embodiment; and

FIG. 11 is a block diagram illustrating a configuration of a game providing device according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Various embodiments will now be described with reference to the accompanying drawings. The embodiments described below may be variously modified. In the following description, those well-known to those of ordinary skill in the art will not be described in detail for more clear descriptions of embodiments.

Moreover, in the present specification, when a portion or element is referred to as being “connected” to another portion or element, the portion or element may be “directly connected” to the other portion or element, or may be connected to the other portion or element “with intervening portions or elements being therebetween.” In addition, it will be further understood that the terms “comprises” and/or “comprising” used herein specify the presence of stated features or elements, but do not preclude the presence or addition of one or more other features or elements.

In addition, although terms such as “first” and “second” are used to describe various elements, these elements should not be limited by these terms. These terms are only used to distinguish one element from another element.

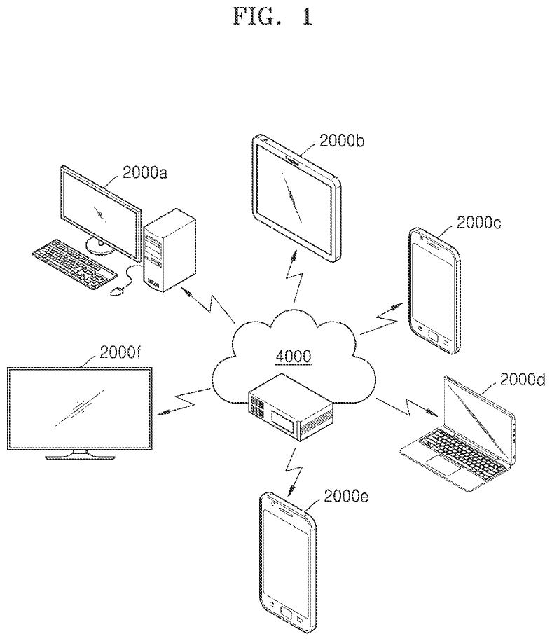

FIG. 1 is a view illustrating an online game providing system including a server and clients according to an embodiment.

According to an embodiment, as shown in FIG. 1, the online game providing system may include a server 4000 and a plurality of clients 2000a, 2000b, 2000c, 2000d, 2000e, and 2000f. The server 4000 may provide a game to the clients 2000a, 2000b, 2000c, 2000d, 2000e, and 2000f by serving the game through a network.

Although FIG. 1 shows a desktop computer, a tablet, a mobile phone, a laptop computer, a smartphone, and a television as examples of the clients 2000a, 2000b, 2000c, 2000d, 2000e, and 2000f, which are used by users, the clients 2000a, 2000b, 2000c, 2000d, 2000e, and 2000f are not limited thereto and may include various electronic devices such as personal digital assistants (PDAs), portable multimedia players (PMPs), navigations, MP3 players, digital cameras, refrigerators, washing machines, and vacuum cleaners.

A game (for example, an online game) may be executed on the clients 2000a, 2000b, 2000c, 2000d, 2000e, and 2000f. A program for executing the game, such as an application or a launcher, may be installed on the clients 2000a, 2000b, 2000c, 2000d, 2000e, and 2000f, but embodiments are not limited thereto. Users may enjoy the game provided by the server 4000 by executing the program installed on the clients 2000a, 2000b, 2000c, 2000d, 2000e, and 2000f. Various embodiments described later may be implemented in the program for executing the game or may be implemented in a program separate from the program.

The server 4000 may be operated by a game provider and may include, but is not limited thereto, a stand-alone server, a group of servers, and a cloud server. The server 4000 may provide the game to users and may include a database for storing user data. In addition, the server 4000 may further include a payment server or a settlement server for generating and processing payment events. The payment server or the settlement server may be a server separate from the server 4000 and may mediate payment or settlement between the server 4000 and the clients 2000a, 2000b, 2000c, 2000d, 2000e, and 2000f. The server 4000 may further include a database (DB) server that stores and manages user data, and the DB server may be a server separate from the server 4000.

A program for servicing the game may be executed on the server 4000. Various embodiments described later may be implemented in the program for servicing the game, or may be implemented in a program separate from the program.

The network may refer to a connection established (or formed) according to a communication method, such as a communication network connected through a communication means for transferring data between the clients 2000a, 2000b, 2000c, 2000d, 2000e, and 2000f or between the server 4000 and the clients 2000a, 2000b, 2000c, 2000d, 2000e, and 2000f.

Examples of the communication means may include communication means using a predetermined communication standard, frequency band, protocol, or channel, short-range communication means, telecommunication means, wireless communication means, and wired communication means. Examples of the communication means may include Bluetooth, Bluetooth low energy (BLE), wireless fidelity (Wi-Fi), Zigbee, 3G, long term evolution (LTE), and ultrasonic-wave communication means, but are not limited thereto.

The short-range communication means may refer to a means, such as Bluetooth and near field communication (NFC) means, which enables communication between devices only when the devices are located within a given range, but embodiments are not limited thereto.

The telecommunication means may refer to a communication means enabling communication between devices regardless of the distance between the devices. Examples of the telecommunication means may include a communication means which enables communication between two devices through a repeater such as an access point (AP) even when the distance between the two devices is greater than a certain range, and a communication means using a cellular network such as 3G and LET networks which are used for text message transmission and phone calls. However, examples of the telecommunication means are not limited thereto.

When the server 4000 provides an online game through a network, the server 4000 and the clients 2000a, 2000b, 2000c, 2000d, 2000e, and 2000f may communicate with each other through an arbitrary communication means.

Examples of the online game may include a role playing game (RPG), a tabletop RPG (TRPG), a massively multiplayer online RPG (MMORPG), multiplayer online battle arena (MOBA), Aeon of Strife (AOS), real time strategy (RTS), first-person shooter (FPS), a trading card game (TCG), a collectible card game (CCG), sport games, and fighting games, but are not limited thereto. The online game may be played as a match between users or a match between a user and a computer (for example, artificial intelligence), but is not limited thereto and may be implemented in various forms.

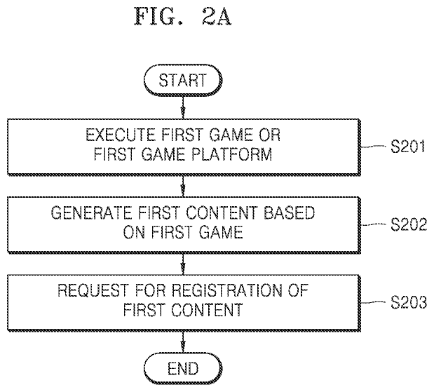

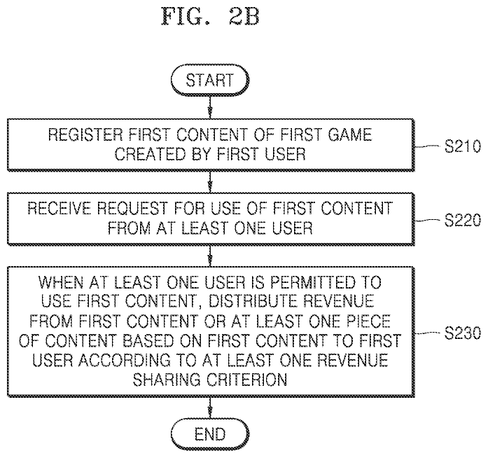

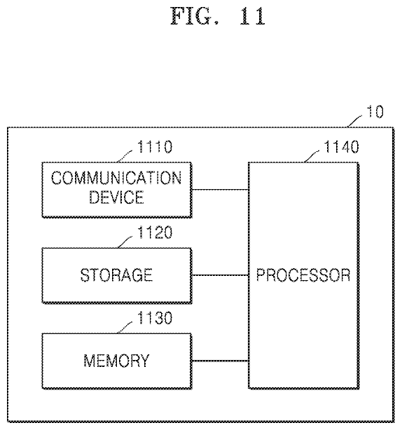

The online game providing system shown in FIG. 1 may also function as an online platform providing system. In addition, the server 4000 shown in in FIG. 1 may correspond to a game providing device 10 (refer to FIG. 11) which is described with reference to in FIGS. 2 to 11. The clients 2000a, 2000b, 2000c, 2000d, 2000e, and 2000f shown in FIG. 1 may correspond to electronic devices of users which are described with reference to FIGS. 2 to 11.

FIG. 2A is a view illustrating a method of operating an electronic device of a user, according to an embodiment.

Referring to FIG. 2A, in operation S201, an electronic device of a first user may execute a first game or a first game platform. The electronic device of the first user may provide an interface allowing the production of content based on the first game by executing the first game or the first game platform. For example, the first game platform may be a system or an operating system provided such that users may produce content related to the first game.

In operation S202, the electronic device of the first user may generate first content based on the first game according to an input from the first user.

The content may be a creative work produced using at least object which is provided in a predetermined game or constitutes a predetermined game. The creative work may be produced based on a predetermined game. In addition, the creative work may be content which may be provided when a predetermined game or a game modified based on the predetermined game is executed or may be provided outside the predetermined game.

For example, the game modified based on the predetermined game may be of the same type as the predetermined game, but may provide at least one modified item. For example, the electronic device of the first user may provide information on a source code constituting the first game through the first game platform. The first user may select source code information from the information on the source code of the first game, and may create a game similar to the first game by using the selected source code information. The electronic device of the first user may create a game based on the selected source code information according to an input of the first user.

For example, content that may be provided when a predetermined game is executed may be a creative work related to items, characters, stages, maps, quests, videos, or the like which are provided in the predetermined game. For example, the electronic device of the first user may provide, through the first game or the first game platform, an interface which is usable to create content to be provided in the first game. For example, the first user may create items, maps, or the like that may be used in the first game. The electronic device of the first user may produce, based on an input of the first user, an item, a map, or the like which is usable in the first game.

For example, the content provided outside the predetermined game may be a creative work which may be provided to a user through a predetermined platform in a state in which the predetermined game is not executed. For example, the first user may create a video which guides a strategy for achieving a predetermined quest in the first game.

In addition, content may refer to content which is directly produced by a user based on a predetermined game platform, or may refer to user-created content (UCC) or user-generated content (UGC).

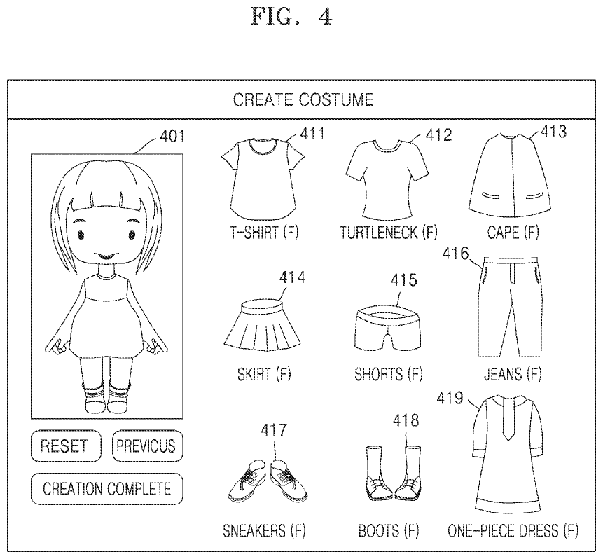

In addition, although FIGS. 4 to 10 illustrate some examples of content, those of skill in the art may conceive of various types of content in the present disclosure.

In operation S203, the electronic device of the first user may request the game providing device 10 to register the first content. The electronic device of the first user may transmit the first content and information on the first content to the game providing device 10. In addition, the electronic device of the first user may transmit information on a revenue sharing criterion for the first content to the game providing device 10.

FIG. 2B is a flowchart illustrating a method of operating the game providing device 10 according to an embodiment.

Referring to FIG. 2B, in operation S210, the game providing device 10 may register the first content of the first game generated by the first user. For example, the first content may be content generated differently from basic content of the first game by using at least one object provided in the first game. Further, the first content may be content related to at least one selected from the group consisting of characters, items, and skins in the first game, but is not limited thereto.

For example, the game providing device 10 may register the first content and revenue sharing information in which at least one revenue sharing criterion is set. Here, the revenue sharing information may include information on a revenue share for the first content or at least one piece of content based on the first content.

In operation S220, the game providing device 10 may receive a request for use of the first content from at least one user.

In operation S230, when the at least one user is permitted to use the first content, the game providing device 10 may distribute revenue, obtained from the first content or at least one piece of content based on the first content, to the first user according to at least one revenue sharing criterion.

For example, the game providing device 10 may distribute first revenue obtained from the at least one piece of content to the first user and the at least one user based on at least one revenue sharing criterion.

Here, revenue distribution may refer to payment of cash of the first game to a predetermined user account of the first game. In addition, revenue may be a benefit provided in the first game.

In addition, the at least one revenue sharing criterion may be determined for equal distribution based on the number of users who have participated in the creation of predetermined content, unequal distribution based on set levels of contribution to the creation of predetermined content, or distribution based on information on agreement between users who have participated in the creation of predetermined content. In addition, a first revenue sharing criterion may be applied to the first content or content based on the first content.

For example, the game providing device 10 may register second content which is based on the first content. Here, the second content, which is based on the first content, may be content produced by a second user who has requested the use of the first content. The game providing device 10 may receive a request for use of the second content from a third user. When the third user is permitted to use the second content, the game providing device 10 may distribute revenue generated from the second content to the first user and the second user based on a second revenue sharing criterion.

In addition, when third content is produced by the third user based on the second content, the game providing device 10 may distribute revenue generated from the third content to the first user, the second user, and the third user based on a third revenue sharing criterion.

For example, the game providing device 10 may receive an input for adjusting the second user's revenue share and the third user's revenue share within a range excluding the first user's revenue share from the total revenue. The game providing device 10 may set a third revenue sharing criterion based on the input for adjusting the second user's revenue share and the third user's revenue share. The game providing device 10 may distribute revenue generated from the third content based on the third revenue sharing criterion.

In addition, the game providing device 10 may monitor, based on a criterion for determining the degree of content similarity, whether content similar to the first content is generated and used in the first game. When fourth content determined to be similar to the first content is detected as a result of monitoring, the game providing device 10 may distribute revenue generated from the fourth content to the first user based on a fourth revenue sharing criterion.

In addition, the game providing device 10 may obtain information on the trend of revenue from the second content which is generated by the second user based on the first content. The game providing device 10 may adjust the first user's revenue share and the second user's revenue share based on the similarity and revenue trend information between the first content and the second content.

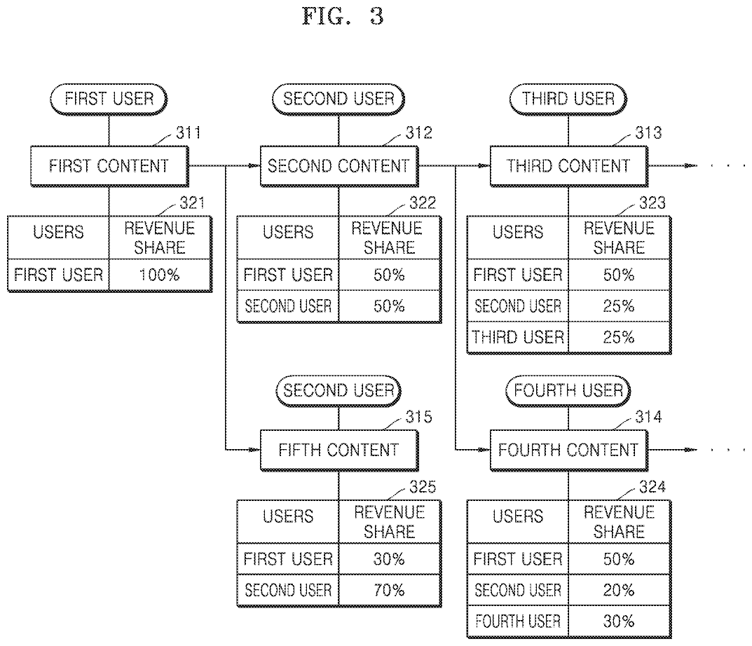

FIG. 3 is a view illustrating a method of distributing revenue obtained from content generated based on first content 311, according to an embodiment.

Referring to FIG. 3, the first content 311 may be created by a first user. For example, the first user may execute a first game on an electronic device of the first user using an account of the first user. The electronic device of the first user may generate the first content 311 in the first game based on an input of the first user. The process of generating the first content 311 will be described with reference to FIG. 4. The first user may register the first content 311 in a store in the first game and may sell the registered first content 311. For example, revenue generated from the first content 311 may be allocated to the first user according to a first revenue sharing criterion. As shown in Table 321, the first revenue sharing criterion may be set such that the first user's revenue share may be 100%.

Meanwhile, a second user may purchase the first content 311. The second user may create second content 312 based on the first content 311. For example, when the first content 311 is a first costume of a character, the second user may create a second costume by adding a predetermined configuration to the first costume or changing the color of the first costume. Because the second costume is generated based on the first costume, revenue generated from the second costume may be distributed to the first user according to a second revenue sharing criterion.

The second revenue sharing criterion may be determined for equal distribution based on the number of users who have participated in the creation of the second content 312, unequal distribution based on set levels of contribution to the creation of the second content 312, or distribution based on information on agreement between users who have participated in the creation of the second content 312.

For example, it is assumed that the second revenue sharing criterion is determined based on agreement information determined by agreement between users. Referring to Table 322, the second user may determine 50% as each user's revenue share for revenue generated from the second content 312 according to an agreement with the first user. The game providing device 10 may distribute revenue generated from the second content 312 to the first user and the second user based on the first user's revenue share and the second user's revenue share.

In addition, the second user may register the second content 312 in a store in the first game and sell the registered second content 312. For example, a third user may purchase the second content 312. The third user may create a third content 313 based on the second content 312. Because the second content 312 is created based on the first content 311, it may be determined that the third content 313 is created by the first user, the second user, and the third user.

Revenue obtained from the third content 313 may be distributed to the first user, the second user, and the third user based on a third revenue sharing criterion.

The second revenue sharing criterion may be determined for equal distribution based on the number of users who have participated in the creation of the third content 313, unequal distribution based on set levels of contribution to the creation of the third content 313, or distribution based on information on agreement between users who have participated in the creation of the third content 313. Here, the agreement between users may mean an agreement between at least two of the first user, the second user, and the third user. Results of the agreement may be applied to only the revenue shares of users who have participating in the agreement.

For example, if there is an agreement on the revenue generated from the third content 313 only between the third user and the second user, the first user's revenue share within the second revenue sharing criterion may be applied to the third revenue sharing criterion. According to an agreement with the second user, the third user may determine equal revenue shares for the revenue obtained from the third content 313. Referring to Table 323, the first user's revenue share is the same as the first user's revenue share in the second revenue share criterion. The second user's revenue share is 25%, and the third user's revenue share is 25%.

In addition, a fourth user may purchase the second content 312. The fourth user may create a fourth content 314 based on the second content 312. Because the second content 312 is created based on the first content 311, it may be determined that the fourth content 314 is created by the first user, the second user, and the fourth user.

Revenue obtained from the fourth content 314 may be distributed to the first user, the second user, and the fourth user based on a fourth revenue sharing criterion.

For example, where there is an agreement on the revenue obtained from the fourth content 314 only between the fourth user and the second user, the first user's revenue share within the second revenue sharing criterion may be applied to the fourth revenue sharing criterion. According to the agreement with the second user, the fourth user may determine the second user's revenue share as 20% and the fourth user's revenue share as 30% for the revenue obtained from the third content 313. Referring to Table 324, the first user's revenue share is the same as the first user's revenue share in the second revenue sharing criterion. The second user's revenue share is 20%, and the fourth user's revenue share is 30%.

In addition, the second user may create a fifth content 315 based on the first content 311. Revenue obtained from the fifth content 315 may be distributed to the first user and the second user based on a fifth revenue sharing criterion. Here, the fifth revenue sharing criterion may be different from the second revenue sharing criterion. As shown in Table 325, the first user's revenue share may be determined as 30%, and the second user's revenue share may be determined as 70%.

FIG. 4 is a view illustrating a process in which a user creates predetermined content in a game, according to an embodiment.

A first user may execute a first game on an electronic device of the first user using an account of the first user. The electronic device of the first user may generate first content in the first game based on an input of the first user.

The first content may be content generated differently from basic content of the first game by using at least one object provided in the first game. Here, the basic content is content that is commonly provided to users playing the first game. The basic content is content that is previously set and provided in the first game, and may not satisfy users in the game. Users may create customized content according to their preferences.

FIG. 4 illustrates an example screen provided such that the first user may create a costume to be put on a character in the first game. Referring to FIG. 4, when a “MAKE COSTUME” menu is selected in the first game, the electronic device of the first user may display a “MAKE COSTUME” screen. For example, a character 401 and a plurality of costumes 411, 412, 413, 414, 415, 416, 417, 418, and 419 that may be put on the character 401 may be displayed on the screen.

For example, when an input for selecting a one-piece dress (female) 419 among the plurality of costumes 411, 412, 413, 414, 415, 416, 417, 418, and 419) is received through the screen, the character 401 may be dressed in the one-piece dress (female) 419.

In addition, an “RESET” button, a “PREVIOUS” button, and a “CREATION COMPLETE” button may be displayed on the screen. When the “RESET” button is selected, the character 401 may be restored to its initial state. In addition, when the “PREVIOUS” button is selected, the character 401 may be restored to its previous state. In addition, when the “CREATION COMPLETE” button is selected, the creation of a first costume for the character 401 may be completed. When the first costume is completed, information on the first costume may be stored based on the account of the first user. For example, the information on the first costume may include at least one piece of information selected from the group consisting of a user who created the first costume, a time when the first costume was produced, and at least one item constituting the first costume.

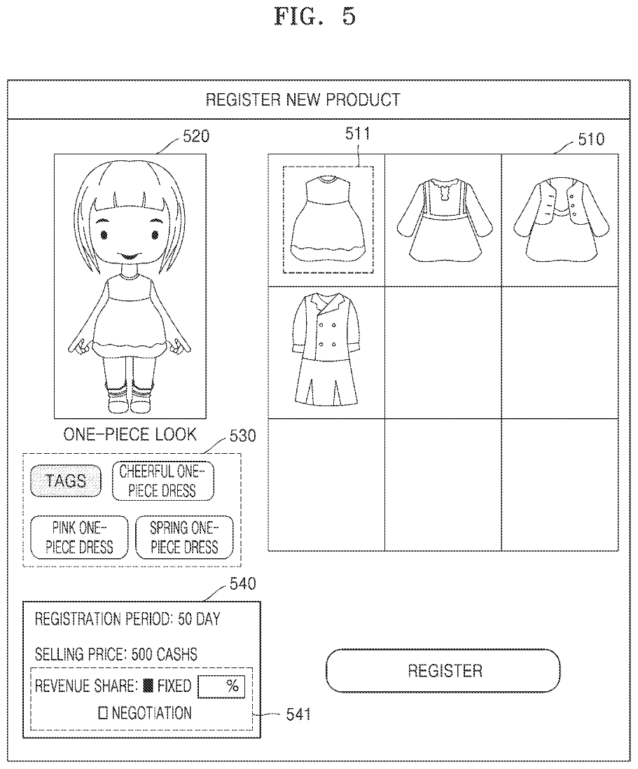

FIG. 5 is a view illustrating a process in which a user registers predetermined content in a game according to an embodiment.

A first user may create first content usable in a first game, and may register the first content in a store in the first game. Once the first content is registered in the store, the first user may sell the first content.

FIG. 5 illustrates an example screen for registering a first costume 511 created by the first user in the store of the first game. Referring to FIG. 5, when a “REGISTER NEW PRODUCT” menu is selected in the first game, an electronic device of the first user may display a “REGISTER NEW PRODUCT” screen. For example, the screen may display costumes 510 created by the first user, a product display region 520 in which a product to be registered is displayed, tag information 530 on the product to be registered, and sales information 540 on the product to be registered.

For example, when an input for selecting the first costume 511 among the costumes 510 created by the first user is received, the first costume 511 may be displayed in the product display region 520 which is for displaying a product to be registered.

In addition, the tag information 530 on the first costume 511 may be recorded based on a user input or may be automatically recorded. For example, words associated with the first costume 511 may be selected as the tag information 530.

In addition, the sales information 540 on the product to be registered may include a registration period during which the first costume 511 will be in the store, selling price of the first costume 511, and revenue sharing information 541 for the first costume 511.

For example, entries for inputting the revenue sharing information 541 may include an entry for setting revenue shares. For example, the entry for setting revenue shares may include a “fixed” entry and a “negotiation” entry. For example, when the first user checks the “fixed” entry, the first user may enter an input for setting a revenue share for revenue obtained from the first costume 511 or content based on the first costume 511.

When a “REGISTER” button is selected on the screen, the first costume 511 may be registered in the store of the first game.

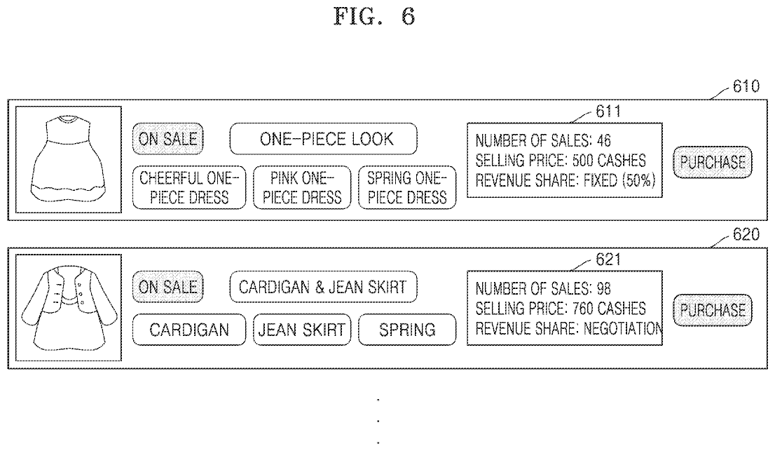

FIG. 6 is a view illustrating a screen displaying registered content in a game, according to an embodiment.

A second user may execute a first game on an electronic device of the second user using an account of the second user. When a “STORE” menu is selected in the first game, the electronic device of the second user may shows a screen on which items that the second user may purchase are displayed. FIG. 6 is an example view illustrating only some of the items that may be purchased for ease of description. For example, FIG. 6 is an example view illustrating information 610 and information 620 which are about costumes registered in the store of the first game.

The information 610 on a first costume may include an image of the first costume, the name of the first costume, tag information on the first costume, and sales information 611 on the first costume. The sales information 611 on the first costume may include the cumulative number of sales of the first costume, the selling price of the first costume, and revenue sharing information for revenue obtained from content based on the first costume.

Similarly, the information 620 on a second costume may include an image of the second costume, the name of the second costume, tag information on the second costume, and sales information 621 on the second costume. The sales information 621 on the second costume may include the cumulative number of sales of the second costume, the selling price of the second costume, and revenue sharing information for revenue obtained from content based on the second costume.

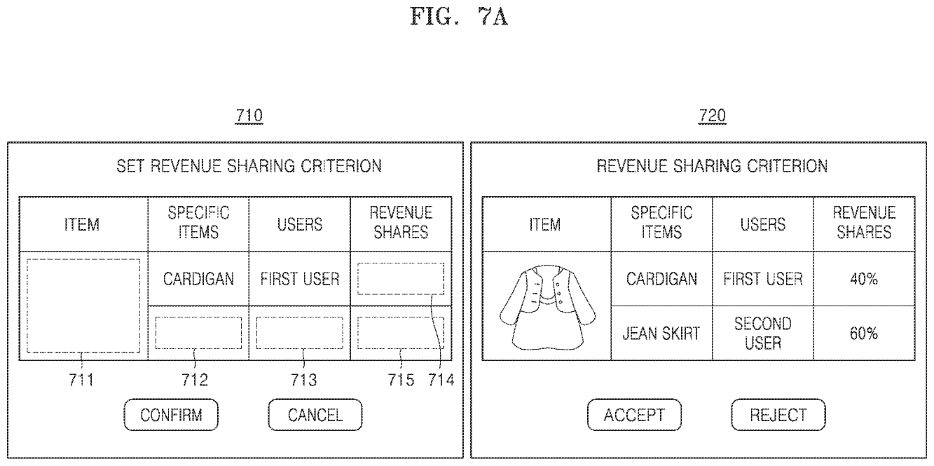

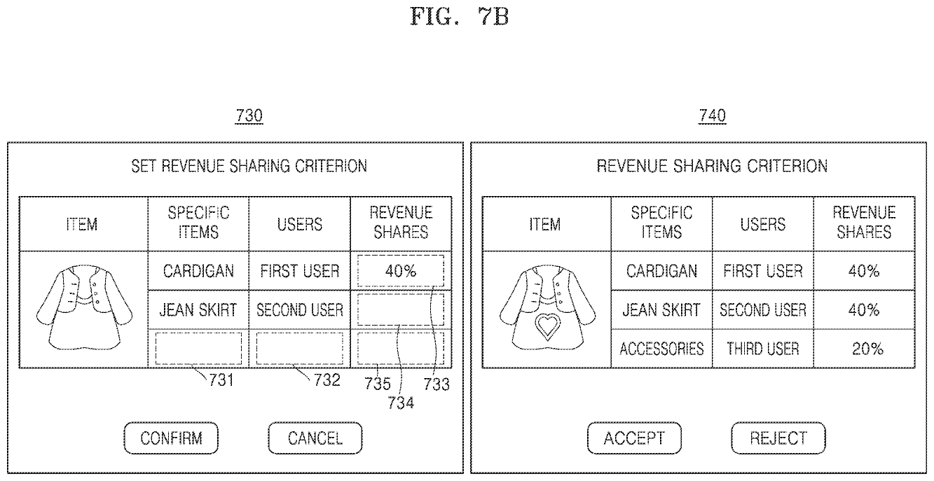

FIG. 7A is a view illustrating a process of setting a revenue sharing criterion according to an embodiment.

A first user may create a “cardigan” as content in a first game. The first user may register the “cardigan” in a store of the first game. A second user may purchase the “cardigan” registered in the store. In this case, the second user may set a revenue sharing criterion related to the “cardigan.”

An electronic device of the second user may execute the first game using an account of the second user. When the “cardigan” is selected on a “store” screen in the first game, revenue sharing information about the “cardigan” may be displayed. When the first user has set the revenue sharing criterion as “negotiation,” the second user purchasing the “cardigan” may set details of the revenue sharing criterion related to the “cardigan.” For example, the revenue sharing criterion related to the “cardigan” may be applied to revenue obtained from costumes prepared by the second user using the “cardigan.”

As shown in an image 710 of FIG. 7A, the electronic device of the second user may display a screen for setting details of the revenue sharing criterion related to the “cardigan.” For example, information 711 on an item to be produced using the “cardigan,” information 712 on a specific item to be fitted with the “cardigan,” user information 713, revenue share information 714, and revenue share information 715 may be set on the screen.

For example, the second user may set the item to be produced using the “cardigan” as “cardigan & jean skirt,” the specific item as “jean skirt,” the user as “second user,” and the first user's revenue share as 40%, and the second user's revenue share as 60%. After settings of the revenue sharing criterion related to the “cardigan” are determined, the game providing device 10 may provide an account of the first user with a screen for confirming whether to accept the settings of the revenue sharing criterion related to the “cardigan.”

As shown in an image 720 of FIG. 7A, an electronic device of the first user may display the screen for confirming whether to accept the settings of the revenue sharing criterion related to the “cardigan.” When the first user agrees to the settings of the revenue sharing criterion set by the second user, the first user may press an “ACCEPT” button, and when the first user does not agree to the settings of the revenue sharing criterion set by the second user, the first user may press a “REJECT” button. At this time, the first user may vary the revenue shares. The game providing device 10 may provide a revenue sharing criterion screen showing the varied revenue shares to the account of the second user. According to the agreement between the first user and the second user, the revenue shares related to the “cardigan” may be determined.

FIG. 7B is a view illustrating a process of setting a revenue sharing criterion according to another embodiment.

The “cardigan & jean skirt” described in FIG. 7A may be registered in the store of the first game. A third user may purchase the “cardigan & jean skirt” registered in the store. In this case, the third user may set a revenue sharing criterion related to “cardigan & jean skirt”.

An electronic device of the third user may execute the first game using an account of the third user. When the “cardigan & jean skirt” is selected on a “store” screen in the first game, revenue sharing information related to the “cardigan & jean skirt” may be displayed. For example, when the second user has set “negotiation” when registering the “cardigan & jean skirt” in the store, the third user purchasing the “cardigan & jean skirt” may set details of a revenue sharing criterion related to the “cardigan & jean skirt.” For example, the revenue sharing criterion related to the “cardigan & jean skirt” may be applied to revenue obtained from costumes created by the third user using the “cardigan & jean skirt.”

As shown in an image 730 of FIG. 7B, the electronic device of the third user may display a screen for setting details of the revenue sharing criterion related to the “cardigan & jean skirt.” For example, a screen may be displayed for setting information 731 on a specific item to be fitted with the “cardigan & skirt,” information 734 on a second user's revenue share, and information 735 on a third user's revenue share. Here, the revenue sharing criterion related to the “cardigan” which is shown in FIG. 7A may be intactly applied to a first user's revenue share 733.

For example, the third user may set an item to be produced using the “cardigan & jean skirt” as “cardigan & heart jean skirt,” the specific item as “accessory,” user as “third user,” and the second user's revenue share as 40%, and the third user's revenue share as 20%. After settings of the revenue sharing criterion related to the “cardigan & heat jean skirt” are determined, the game providing device 10 may provide the account of the second user with a screen for confirming whether to accept the settings of the revenue sharing criterion related to the “cardigan & heart jean skirt.”

As shown in an image 740 of FIG. 7B, the electronic device of the second user may display the screen for confirming whether to accept the settings of the revenue sharing criterion related to the “cardigan & heart jean skirt.” When the second user agrees to the settings of the revenue sharing criterion set by the third user, the second user may press an “ACCEPT” button, and when the second user does not agree to the settings of the revenue sharing criterion set by the third user, the second user may press a “REJECT” button. At this time, the second user may vary the revenue shares. The game providing device 10 may provide a revenue sharing criterion screen showing the varied revenue shares to the account of the third user. According to the agreement between the second user and the third user, the revenue shares related to the “cardigan & heat jean skirt” may be determined.

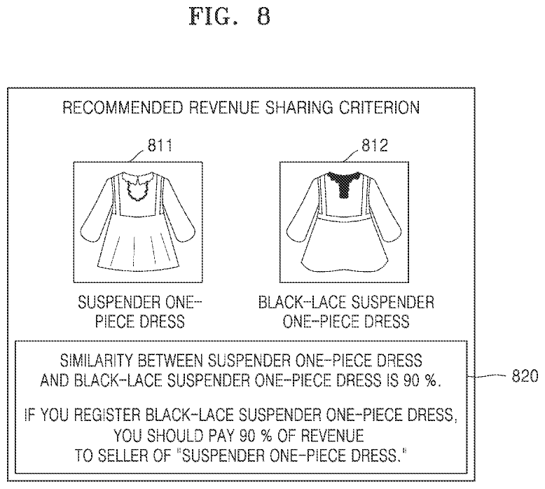

FIG. 8 is a view illustrating a process of recommending a revenue sharing criterion when content similar to registered content is detected, according to an embodiment.

Based on a criterion for determining the degree of content similarity, the game providing device 10 may monitor whether content similar to registered content is generated and used in a first game. For example, the degree of content similarity may be determined based on whether or not elements constituting content overlap each other. For example, when the proportion of overlapping elements of content exceeds a predetermined value, it may be determined that the degree of content similarity is high. For example, elements of content may include: external elements which are displayed to the outside; and internal elements including a source code which are used to implement the content.

Referring to FIG. 8, a first user may create a “black-lace suspender one-piece dress” 812 and may attempt to register the “black-lace suspender one-piece dress” 812 in a store. The game providing device 10 may monitor whether content registered in the store includes a costume similar to the “black-lace suspender one-piece dress” 812. As a result of monitoring, the game providing device 10 may determine that a “suspender one-piece dress” 811 among registered costumes is similar to the “black-lace suspender one-piece dress” 812. The game providing device 10 may provide the first user with a message which contains information on the degree of content similarity and indicates that revenue obtained from the “black-lace suspender one-piece dress” 812 may be distributed to a seller who has registered the “suspender one-piece dress” 811.

An electronic device of the first user may display a message 820 stating “The degree of similarity between the black-lace suspender one-piece dress and the suspender one-piece dress is 90%. If you register the black-lace suspender one-piece dress, you should pay 90% of revenue to the seller of the suspender one-piece dress” as shown in FIG. 8

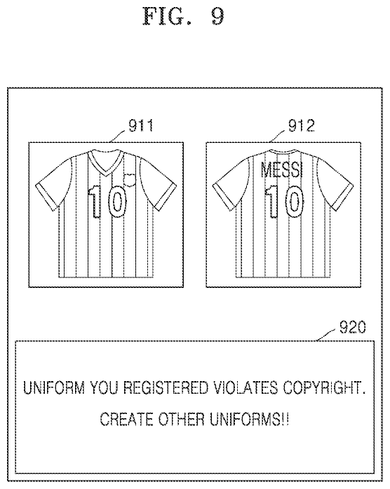

FIG. 9 is a view illustrating a screen for displaying a warning message when content generated by a user violates a predetermined criterion, according to an embodiment.

The game providing device 10 may monitor whether content generated by a user violates a criterion which is previously set in a game. For example, the predetermined criterion which is previously set may be not to infringe copyright, trademark rights, portrait rights, and the like. When results of monitoring show that content generated by a user violates the predetermined criterion, the game providing device 10 may provide a warning message to an account of the user.

When a first user produces a costume (refer to reference numerals 911 and 912 in FIG. 9) related to a famous soccer player as shown in FIG. 9, an electronic device of the first user may display a message 920 stating “The uniform you attempt to register violates copyright. Try to create a different uniform!!”

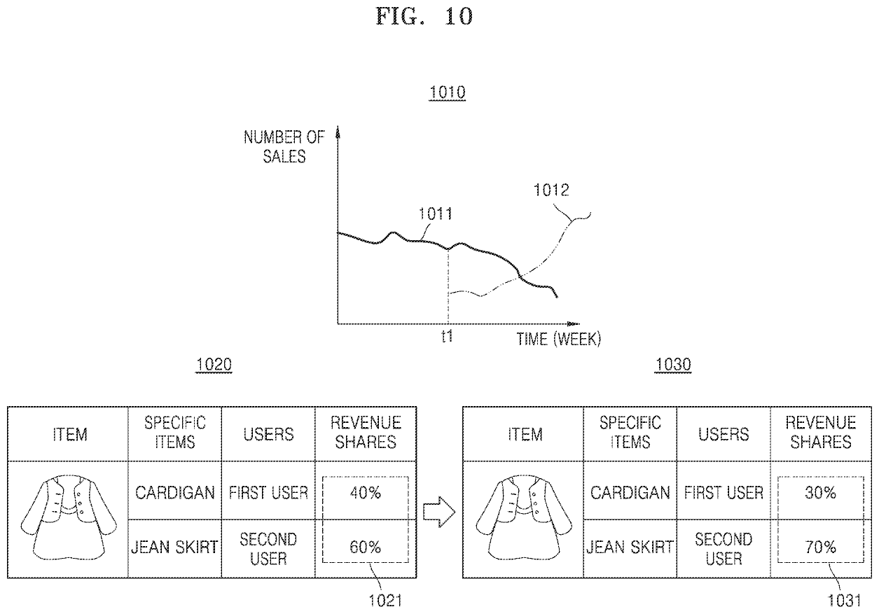

FIG. 10 is a view illustrating a process of adjusting a revenue sharing criterion based on information about the trend of revenue obtained from second content, which is generated based on first content, and the similarity between the first content and the second content, according to an embodiment.

The graph 1010 in FIG. 10 shows the number of sales 1011 of the first content and the number of sales 1012 of the second content with respect to time. Here, the second content is content generated based on the first content. In addition, t1 refers to a time point at which the second content is registered and goes on sale. In addition, it is assumed that the first content is generated by a first user and the second content is generated by a second user. For example, the second content may be a costume representing “cardigan & jean skirt.” The first content may be a costume representing “cardigan.”

Table 1020 in FIG. 10 shows a revenue sharing criterion which is initially set for the “cardigan & jean skirt”. For example, as indicated with reference numeral 1021, the first user's revenue share is 40%, and the second user's revenue share is 60%.

As shown in the graph 1010 of FIG. 10, after the time point t1, the number of sales of the first content decreases, and the number of sales of the second content increases.

In addition, because the second content is generated based on the first content, the second content may have many similarities to the first content. The game providing device 10 may adjust the first and second users' shares of revenue from the second content based on the similarity between the first content and the second content, the trend of revenue from the first content, and the trend of revenue from the second content.

For example, referring to reference numeral 1031 in Table 1030 of FIG. 10, the game providing device 10 may adjust the first user's revenue share to be 30% and the second user's revenue share to be 70%. Alternatively, the game providing device 10 may adjust revenue shares based on an agreement between users.

FIG. 11 is a block view illustrating the game providing device 10 according to an embodiment.

The game providing device 10 may include a communication device 1110, a storage 1120, a memory 1130, and a processor 1140. However, not all of the illustrated components are essential components. The game providing device 10 may be implemented by more components than the illustrated components, or by fewer components than the illustrated components. Hereinafter, the components of the game providing device 10 will be described.

The communication device 1110 may communicate with external devices. For example, the communication device 1110 may be connected to a network in a wired or wirelessly manner for communication with external devices. Here, the external devices may include servers, smartphones, tablets, or PCs. The communication device 1110 may include a communication module which supports one of various wired and wireless communication methods. For example, the communication module may be in the form of a chipset, a sticker/barcode (e.g., a sticker including an NFC tag) including information necessary for communication, or the like. In addition, the communication module may be a short-range communication module or a wired communication module.

For example, the communication device 1110 may support at least one selected from the group consisting of wireless LAN (wireless LAN), Wi-Fi, Wi-Fi direct (WFD), Bluetooth, BLE, wired LAN, near field communication (NFC), Zigbee, infrared data association (IrDA), 3G, 4G, and 5G.

The storage 1120 may store revenue sharing information including log data of a plurality of users in a game, content registered by the plurality of users, revenue sharing criteria for the content, etc. The storage 1120 may store information related to a program, an application, or the like which is used to distribute revenue generated from content. The storage 1120 may store programs and applications to be executed on the game providing device 10, and various types of data used on a server.

The memory 1130 may store software or programs. In addition, the memory 1130 may store instructions used to distribute revenue obtained from content.

The processor 1140 may control the overall operation of the game providing device 10 and may include at least one processor such as a CPU. The processor 1140 may include at least one specialized processor corresponding to each function, or may be an integrated type of processor.

The processor 1140 may execute a program stored in the memory 1130, read data or files stored in the memory 1130, or store a new file in the memory 1130. The processor 1140 may execute instructions stored in the memory 1130.

The processor 1140 may register first content generated by a first user in a first game. For example, the first content may be content generated differently from basic content of the first game by using at least one object provided in the first game. In addition, the first content may be related to at least one selected from the group consisting of characters, items, and skins in the first game, but is not limited thereto.

For example, the processor 1140 may register the first content together with revenue sharing information in which at least one revenue sharing criterion is set. Here, the revenue sharing information may include information on a revenue distribution ratio for the first content or at least one piece of content which is based on the first content.

The processor 1140 may receive a request for use of the first content from at least one user's electronic device through the communication device 1110.

When at least one user is permitted to use the first content, the processor 1140 may distribute revenue, which is generated from the first content or at least one piece of content generated based on the first content, to the first user according to at least one revenue sharing criterion.

For example, the processor 1140 may distribute first revenue generated from at least one piece of content to the first user and at least one other user according to at least one revenue sharing criterion.

In addition, the at least one revenue sharing criterion may be determined for equal distribution based on the number of users who have participated in the creation of predetermined content, unequal distribution based on set levels of contribution to the creation of predetermined content, or distribution based on information on agreement between users who have participated in the creation of predetermined content. In addition, a first revenue sharing criterion may be applied to the first content or content generated based on the first content.

For example, the processor 1140 may register second content which is based on the first content. Here, the second content which is based on the first content may be content generated by a second user who has requested permission to use the first content. The processor 1140 may receive a request for use of the second content from an electronic device of a third user through the communication device 1110. When the third user is permitted to use the second content, the processor 1140 may distribute revenue generated from the second content to the first user and the second user based on a second revenue sharing criterion.

In addition, when third content is generated by the third user based on the second content, the processor 1140 may distribute revenue generated from the third content to the first user, the second user, and the third user according to a third revenue sharing criterion.

For example, the processor 1140 may receive an input for adjusting the second user's revenue share and the third user's revenue share within a range excluding the first user's revenue share from the total revenue. The processor 1140 may set the third revenue sharing criterion based on an input for adjusting the second user's revenue share and the third user's revenue share. The game providing device 10 may distribute revenue generated from the third content according to the third revenue sharing criterion.

In addition, based on a criterion for determining the degree of content similarity, the processor 1140 may monitor whether content similar to the first content is generated and used in the first game. When results of the monitoring shows that fourth content determined to be similar to the first content is detected, the processor 1140 may distribute revenue generated from the fourth content to the first user according to a fourth revenue sharing criterion.

In addition, the processor 1140 may obtain information about the trend of revenue obtained from the second content which is generated by the second user based on the first content. The processor 1140 may adjust the first user's revenue share and the second user's revenue share based on the similarity between the first content and the second content, the trend of revenue obtained from the first content, and the trend of revenue obtained from the second content.

The game providing device 10 described above may be implemented using a hardware component, a software component, and/or a combination thereof. For example, the devices and components illustrated in the embodiments may be implemented using one or more general-purpose or special-purpose computers, such as, a processor, a controller, an arithmetic logic unit (ALU), a digital signal processor, a microcomputer, a field programmable gate array (FPGA), a programmable logic unit (PLU), a microprocessor or any other device capable of responding to and executing instructions. A processing device may run an operating system (OS) and one or more software applications that run on the OS. The processing device also may access, store, manipulate, process, and create data in response to execution of the software. For purpose of simplicity, the case of using only one processing device may be described; however, one skilled in the art will appreciated that a processing device may include multiple processing elements and/or multiple types of processing elements. For example, a processing device may include multiple processors or may include a processor and a controller. In addition, different processing configurations are possible, such as parallel processors.

The software may include a computer program, a piece of code, an instruction, or one or more combinations thereof, to independently or collectively instruct or configure the processing device to operate as desired. Software and/or data may be embodied permanently or temporarily in any type of machine, component, physical or virtual equipment, or computer storage medium or device, or in a propagated signal wave in order to provide instructions or data to the processing device or to be interpreted by the processing device. The software may also be distributed over network coupled computer systems so that the software is stored and executed in a distributed fashion. The software and data may be stored in one or more non-transitory computer readable recording mediums.

The methods according to the embodiments may be realized as program instructions implemented by various computers and be recorded in non-transitory computer-readable media. The non-transitory computer-readable media may include, alone or in combination with the program instructions, data files, data structures, and the like. The program instructions recorded in the media may be designed and configured specially for the embodiments or be known and available to those skilled in computer software. Examples of the non-transitory computer-readable recording media may include magnetic media such as hard disks, floppy disks, and magnetic tape; optical media such as CD ROMs and DVDs; magneto-optical media such as floptical disks; and hardware devices that are specially configured to store and perform program instructions, such as read-only memory (ROM), random access memory (RAM), flash memory, and the like. Examples of program instructions include both machine codes, such as produced by a compiler, and high-level language codes that may be executed by a computer using an interpreter. The described hardware devices may be configured to act as one or more software modules in order to perform the operations of the above-described example embodiments, or vice versa.

When a plurality of users have contributed to the creation of a content in a game, revenue obtained from the content may be distributed to the plurality of users according to a predetermined criterion.

Revenue obtained from content of a game may be distributed to users to make the game more popular and users more interested in the game.

In addition, a user who has created content based on which another content is created may be rewarded.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of operating a game providing device, the method comprising:
registering first content which is created by a first user in a first game;
receiving a request for use of the first content from at least one user; and
when the at least one user is permitted to use the first content, distributing revenue obtained from the first content or at least one piece of content which is based on the first content to the first user according to at least one revenue sharing criterion.

2. The method of claim 1, wherein when the at least one piece of content which is based on the first content is created by the at least one user, the distributing of the revenue comprises distributing revenue obtained from the at least one piece of content to the first user and the at least one user according to the at least one revenue sharing criterion.

3. The method of claim 1, wherein the at least one revenue sharing criterion is determined for equal distribution based on a number of users who have participated in creating content, unequal distribution based on set levels of contribution to creating content, or distribution based on information on agreement between users who have participated in creating content.

4. The method of claim 1, wherein the first content is created differently from basic content of the first game by using at least one object provided in the first game.

5. The method of claim 1, wherein the first content is related to at least one selected from the group consisting of characters, items, and skins of the first game.

6. The method of claim 1, wherein the registering of the first content comprises registering revenue sharing information in which the at least one revenue sharing criterion is set, the at least one revenue sharing criterion comprising a revenue distribution ratio for the first content or the at least one piece of content which is based on the first content.

7. The method of claim 1, further comprising:
registering second content which is created based on the first content by a second user who has requested use of the first content,
receiving a request for use of the second content from a third user; and
when the third user is permitted to use the second content, distributing revenue obtained from the second content to the first user and the second user according to a second revenue sharing criterion.

8. The method of claim 7, wherein when third content is created by the third user based on the second content, the method further comprises distributing revenue obtained from the third content to the first user, the second user, and the third user according to a third revenue sharing criterion.

9. The method of claim 8, wherein the distributing of the revenue obtained from the third content according to the third revenue sharing criterion comprises:
receiving an input for adjusting a second user's revenue share and a third user's revenue share within a range excluding a first user's revenue share from the second revenue sharing criterion;
setting the third revenue sharing criterion based on the input for adjusting the second user's revenue share and the third user's revenue share; and
distributing revenue obtained from the third content according to the third revenue sharing criterion.

10. The method of claim 1, further comprising:
monitoring, based on a criterion for determining a degree of content similarity, whether content similar to the first content is created and used in the first game; and
when fourth content determined to be similar to the first content is detected as a result of the monitoring, distributing revenue obtained from the fourth content to the first user according to a fourth revenue sharing criterion.

11. The method of claim 1, further comprising:
acquiring information on a trend of revenue obtained from second content which is created by a second user based on the first content; and
adjusting a first user's revenue share and a second user's revenue share based on similarity between the first content and the second content and the information on the trend of revenue.

12. A computer program stored in a non-transitory medium for executing a method of operating a game providing device in combination with the game providing device, wherein the method comprises:
registering first content which is created by a first user in a first game;
receiving a request for use of the first content from at least one user; and
when the at least one user is permitted to use the first content, distributing revenue obtained from the first content or at least one piece of content which is based on the first content to the first user according to at least one revenue sharing criterion.

13. A non-transitory computer-readable recording medium having recorded thereon a program for executing the method of operating a game providing device of claim 1.

14. A game providing device comprising:
a communication device;
a storage;
a processor; and
a memory storing instructions executable by the processor,
wherein the processor executes the instructions to:
register first content which is created by a first user in a first game;
receive a request for use of the first content from at least one user; and
when the at least one user is permitted to use the first content, distribute revenue, obtained from the first content or at least one piece of content which is based on the first content, to the first user according to at least one revenue sharing criterion.

15. The game providing device of claim 14, wherein when the at least one piece of content which is based on the first content is created by the at least one user, the processor executes the instructions to distribute revenue obtained from the at least one piece of content to the first user and the at least one user according to the at least one revenue sharing criterion.

16. The game providing device of claim 14, wherein the at least one revenue sharing criterion is determined for equal distribution based on a number of users who have participated in creating content, unequal distribution based on set levels of contribution to creating content, or distribution based on information on agreement between users who have participated in creating content.

17. The game providing device of claim 14, wherein the processor executes the instructions to:
register second content which is created based on the first content by a second user who has requested use of the first content;
receive a request for use of the second content from a third user; and
when the third user is permitted to use the second content, distribute revenue obtained from the second content to the first user and the second user according to a second revenue sharing criterion.

18. The game providing device of claim 17, wherein when third content is created by the third user based on the second content, the processor executes the instructions to distribute revenue obtained from the third content to the first user, the second user, and the third user according to a third revenue sharing criterion.

19. The game providing device of claim 18, wherein the processor executes the instructions to:
receive an input for adjusting a second user's revenue share and a third user's revenue share within a range excluding a first user's revenue share from the second revenue sharing criterion;
set the third revenue sharing criterion based on the input for adjusting the second user's revenue share and the third user's revenue share; and
distribute revenue obtained from the third content according to the third revenue sharing criterion.

20. The game providing device of claim 14, wherein the processor executes the instructions to:
monitor, based on a criterion for determining a degree of content similarity, whether content similar to the first content is created and used in the first game; and
when fourth content determined to be similar to the first content is detected as a result of the monitoring, distribute revenue obtained from the fourth content to the first user according to a fourth revenue sharing criterion.
